(19) United States
(12) Patent Application Publication
(10) Pub. No.: US 2021/0203114 A1
(43) Pub. Date: Jul. 1, 2021

(54) UNIVERSAL POWER OUTLET STRIP FOR BOTH PORTABLE AND STATIONARY USE

(71) Applicant: Jakko Hansu Yang, Pleasanton, CA (US)

(72) Inventor: Jakko Hansu Yang, Pleasanton, CA (US)

(21) Appl. No.: 16/727,845

(22) Filed: Dec. 26, 2019

(51) Int. Cl. H01R 31/02; H01R 31/06

(52) U.S. Cl. CPC H01R 31/02; H01R 2201/06; H01R 31/06

(57) ABSTRACT

A simple, low cost, compact, robust and one-part-for-all power supply strip with multiple power outlets is presented. Power input is from a male connector that a standard desktop PC usually uses. Power outputs are through the combination geometry configuration outlets that are to electro-mechanically engage plugs with configurations for various major countries in the world. In use, it would support 100 VAC to 240 VAC, 50 Hz or 60 Hz input with minimum 10 amp rating.

### FIELD OF THE INVENTION

The present disclosure generally relates to an apparatus for adapting a power outlet to a power outlet strip of most of countries in the world. More particularly, the present disclosure relates to a universal, simple, low cost, compact, robust and one-part-for-all power outlet strip.

### BACKGROUND OF THE INVENTION

As technology advances and economy goes global, not only the number of power-requiring electronic devices increases but also these increases are from different countries in the world. The power outlet strip provides a means for distributing power from a single power outlet to multiple electronic devices. Therefore, the desire and applications for use of power outlet strips will continue to increase in the future. For example, having several mobile devices to charges simultaneously is also becoming very common practice. Only one power outlet is not enough anymore.

The need for multiple power outlets is not limited at one's home or office. Motel & hotel accommodations, cruise ship cabins, camping site etc only offer a limited number of power outlets. The traveler would benefit from having a plurality of power outlets available in a close proximity, so that a laptop computer power adapter, a cellular phone power adapter etc can be used at the same time. The regular conventional power strips are designed to be plugged into a single power outlet configuration. The series of sockets are normally with the same configuration for a specific country or a small group of specific countries, thus limiting the application to countries having different power outlet configurations. Travelers frequently encounter situations in a foreign country where a universal power strip would be beneficial.

However, due to historical reasons, configurations of power plugs and outlets themselves are not universal and they are difficult to change from one configuration to another configuration. Many power outlets type are only valid in specific countries. US department of commerce has a list of more than 10 different configuration types for various countries. These configurations already cover vast majority of world economy.

Following types are among the most common configurations of power outlets. Type A: USA, Canada, China Taiwan, Japan (compatible with Type B); Type B: American Samoa, Antigua & Barbuda, Aruba, Bahamas, Barbados, Belize, Bermuda, Canada, Cayman Islands, Colombia, Costa Rica, Cuba, Ecuador, El Salvador, Guam, Guatemala, Haiti, Honduras, Jamaica, Japan, Liberia, Mexico; Type C: Brazil (Compatible with type E/F); Type D: India, Pakistan; Type E/F: France, Germany, South Korea; Type G: United Kingdom, Ghana, Gibraltar, Grenada, China Hong Kong, Iraq; Type H: Israel; Type I: Australia, China, New Zealand; Type J: Switzerland; Type K: Brazil; Type L: Italy, Uruguay; Type M: South Africa.

The list above means that many different kinds of power outlet strips are needed inevitably for people from different parts of world.

The good news is that many newer power supply nowadays are using so-called Switch Mode Power Supplies (SMPS) , This kind of device power adapters are designed to work from 100V AC to 240V AC, either 50 HZ or 60 HZ. SMPS is popular for devices like cell phone charger, modem, router, laptop, monitor, loudspeakers, home play station etc. Desk top PC power supplies usually have also optional switch in order to support all configurations in the world in term of voltage and frequency.

It is a fact that SMPS has replaced in most cases the traditional linear ac-to-dc power supplies as a way to reduce power consumption, heat dissipation, as well as reduce size and weight. Nowadays SMPS is getting predominately available worldwide.

Therefore, it is now possible to put 110V configuration and 220V configuration in the same power outlet. In fact some airlines already use it in on-board airplane for this reason as single power outlet. Some hotels also start doing the same or similar things. It now also makes it possible that different device using different power outlet configurations from different countries to be plugged into the same single power strip without a power transformer needed.

Currently in the market, very few power strips can cover most of countries at a time. There are already some prior arts that are trying to address the issues of power outlet strips from different countries. The most cost effective plug and socket converter strips in prior arts usually cover six or seven types of configurations with additional adapter parts needed.

However, problems arise in those prior arts.

The first disadvantage of prior arts is that they are quite expensive and complicated to manufacture. If whole thing is more expensive it will hurt marketing and sale volume. Cost is usually number one factor that consumers consider.

The second disadvantage of prior arts is that there are too many parts. Rule of thumb is that more parts, more complicated, then more expensive; the less parts, less expensive, then more compact and reliable.

The third disadvantage of prior arts is that it will become not truly universal if one accessory part is accidentally missing. For travelers, missing one part could happen quite often at any time during travel. Once one part is missing it becomes less universal and less useful.

The fourth disadvantage of prior arts is that it is quite bulky. It is hard to put into luggage to travel due to the fact that there is always limited space during transit. Now airlines commonly charge travelers for check-in luggage. Travelers then tend to carry less for travel.

The fifth disadvantage of prior arts is that it become also heavier once it is bulky and it is hard to carry even it can be put into luggage. Nowadays airlines not only charge travelers for check-in luggage but also charge even more if the luggage is overweight.

The sixth disadvantage of prior arts is that there is only one power outlet for a specific country or a small group of countries at a time. Therefore, convenience is seriously compromised. Users would need multiple power outlets for one specific country at the same time just for convenience, not just one power outlet for each of different country at a time. For stationary application, people usually need at least two power sockets available at a power outlet strip. Desk top PC and monitor already take two outlet sockets. For traveler in a foreign country, it would be really convenient if there are at least three outlets available at a time.

Therefore, it would be desirable to have a power outlet strip capable of powering a series of electrically operated devices throughout the most part of the world. A much simpler, more compact, more universal, more durable power strip is preferred.

To overcome the disadvantages of prior arts, here are advantages of current invention:

The first advantage of current invention is that its manufacture cost is very low. Low cost is the key to success. Lower the cost, higher the sale volume. If the cost is low enough then people may even purchase multiple pieces of this product. The chance to success would be much higher.

The second advantage of current invention is that it is a one-part-for-all solution. There is only one part, one body. One-piece is simple, and simple also means compact and robust.

The third advantage of current invention is that there is no problem for a missing part. User either would have it or not have it. If it is lost just buy another power outlet strip of this kind at low price anyway.

The fourth advantage of current invention is that it is much more universal. Unlike that in prior arts that require different adapters for different countries, this product from current invention can go with much more countries without needs for adapter for specific countries. It is really intended to be marketed and sold worldwide as a piece of universal product.

The fifth advantage of current invention is that it is compact in size, it is much less bulky. It can easily fit into travel bags for travelers.

The sixth advantage of current invention is that it is light weight, it is easy to carry. Travelers do not have to worry about its overweight problem.

The seventh advantage of current invention is that it is a scalable solution. It can be manufactured as three or even more power outlets. Manufacturer can easily simply add support for much more countries just by adding more supports for outlet combination configuration types, or even possible to configured to support every single country in the world.

The eighth advantage of current invention is that it is not only for mobile applications but also for stationary applications. In fact, desktop PC is so popular that a power cord with female IEC-320-C13 connector is easy to find everywhere at very low cost. A standard desk PC power cord usually is designed to support minimum 10A. Stationary electrical apparatus includes printer, paper shredder, desk lamp, microwave oven, toast oven etc. Therefore In this invention, if it is used in home & office it then also acts just like a regular household power strip. And travelers can also take it to a foreign country to use in vacation home & vacation office as a stationary power outlet solution.

The ninth advantage of current invention is that it is not only for consumers but also for industry. Because it is just a regular power outlet strip with regular power rating. Factory can ship one or more of this kind power outlet strips along with their industrial product to foreign customers to avoid connector configuration mismatch problems in different countries.

Power outlet configurations from different countries can already be in the same power strip due to device SMPS power 100-240 V range and 50/60 Hz support. Other less mobile device like toaster oven, microwave ovens, printer, paper shredder, vacuum cleaner etc are usually sold for use in specific country already with correct voltage, either 110V or 220V, either 50 Hz or 60 Hz. All needed is to choose a correct socket to plug in. Specific appliance usually has specifications to indicate the use at specific countries or area. These appliances cannot be used in another country. When travelers carry this product of current invention to a foreign country, the travelers can easily use this product in the foreign country to join local configuration in order to use these appliances. Therefore, this product with current invention can easily be sold into a foreign country.

Then when a mobile SMPS device comes in from a foreign country, it can just directly plug in because this mobile SMPS device supports 100-240V AC and 50/60 Hz. Therefore, use of this invention is still valid in this particular country. Country specific appliances and a foreign mobile device can coexist peacefully in the same power outlet strip with current invention.

IEC-320-C13 female connector at a power cord and male pin IEC-320-C14 male PC are universal connectors for desktop and monitor power input worldwide.

When a PC is sold to foreign country, usually the only thing needed is to provide the power cord cable with the local power configuration plug at one end and the female IEC-320-C13 connector at other end. This power cord is usually very popular and easy to find even in a specific country at very low cost.

In the worst case, a world traveler can carry a short low cost spare power cord, a single universal plug adapter that is easy to find in the market, plus this product with current invention. It would be still overall much better than prior arts.

Portable electronic devices, such as cellular telephones can also utilize charging interfaces directly through a Universal Serial Bus (USB) interface with limited USB DC amperage rating. Adding USB power outlet support is also an option. But the smartest strategy is still to keep it simple. A regular switch can also be added as an option.

### SUMMARY OF THE INVENTION

The present disclosure is generally directed to universal power outlet strip. The power outlet strip has only one casing body. The power input is through a universally standard male connector that is used for a standard desktop PC. Power outlets are the sockets with combination outlet geometry configurations for various different countries simultaneously. A USB power outlet add-on is optional. It can also act like a regular power outlet strip. It is a low cost, compact, simple, robust and one-part-for-all power outlet strip. It can usually support 100-240 VAC, 50-60 Hz with at least 10 amp rating. These and other features, aspects, and advantages of the invention will be further understood and appreciated by those skilled in the art by reference to the following written drawings and claims.

### BRIEF DESCRIPTION OF THE DRAWINGS

FIG. 1 shows a typical set of exemplary universal power outlet strip in current invention.

FIG. 2 shows a typical power outlet combination configuration diagram for use with various countries.

FIG. 3 shows a typical United Kingdom power outlet configuration.

FIG. 4 shows standard diagram of a typical set of IEC-320-C13 female connector and IEC-320-C14 male connector.

FIG. 5 shows a typical application of current universal power outlet strip in use together with a power cord.

FIG. 6 shows a typical set of exemplary universal power outlet strip with optional USB power outlet.

### DETAILED DESCRIPTION OF THE PRESENT INVENTION

The present invention is a low cost one-piece universal power outlet strip.

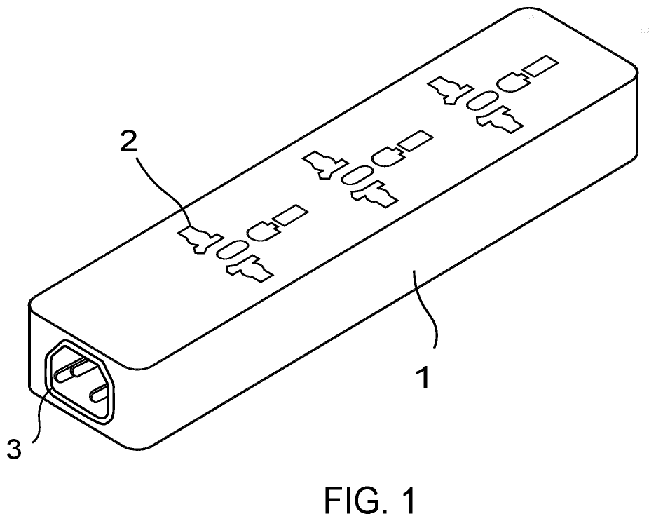

Referring FIG. 1, a universal power outlet strip comprises casing body 1, power input IEC-320-C14 male connector 3 and combination configuration power outlets 2. The casing body is usually made of plastics. The figure shows that power comes into casing body through an IEC-320-C14 male connector 3. Then power outlet strip distributes the power through combination configuration power outlets 2. Its design of compactness and robustness make sure it is safe to use and easy to carry around.

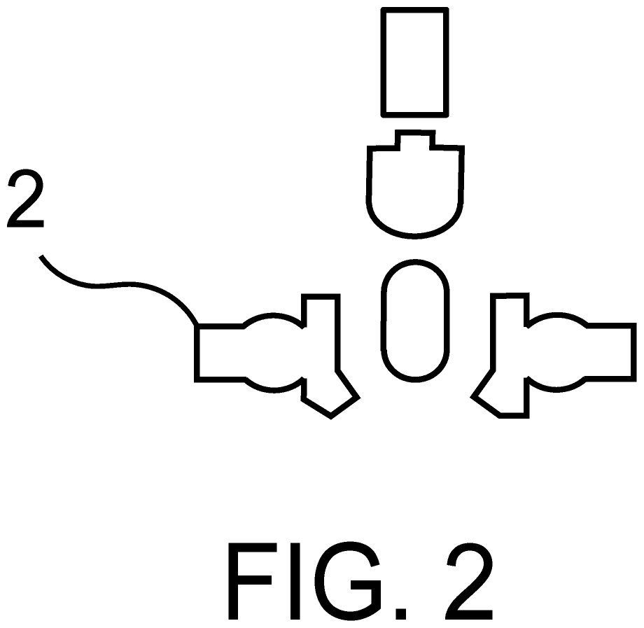

FIG. 2 shows a typical diagram of combination configuration power outlets 2 for use with multiple countries. There might be several different variations for this diagram design depending on cost and intended coverage of countries.

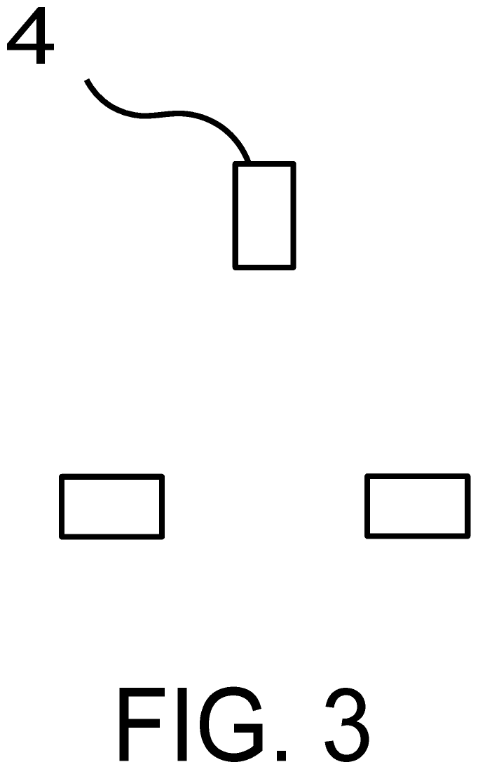

FIG. 3 shows a typical United Kingdom power outlet diagram 4. It has the largest outer dimension among many other different power outlets from different countries. The size of United Kingdom power plug then decides the overall size of this universal power outlet strip. A single UK power plug will easily fit into the current combination configuration power outlets 2.

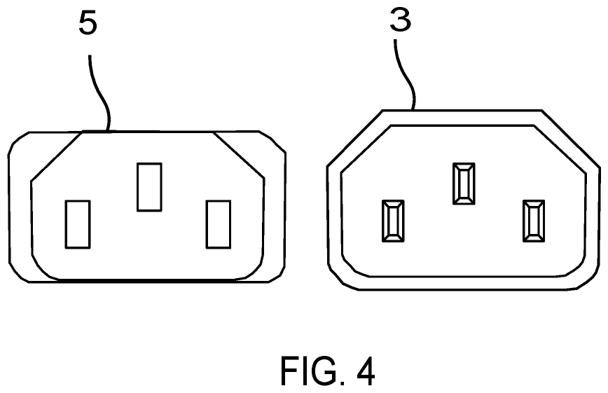

FIG. 4 shows a standard diagram of IEC-320-C13 connector 5 and IEC-320-C14 connector 3 diagram. IEC-320-C13 connector 5 is female connector that is usually located at one end of a PC power cord. IEC-320-C14 connector 3 is male connector that is usually located at body of a standard PC, monitor or other common instruments.

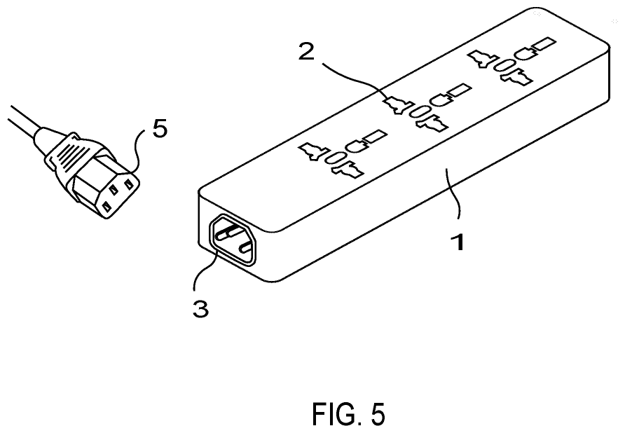

FIG. 5 shows that current universal power outlet strip is in use with a power cord. There is an IEC-320-C13 female connector 5 at one end of the power cord. The IEC-320-C13 female connector 5 is to be engaged into IEC-320-C14 male connector 3 at power strip body 1.

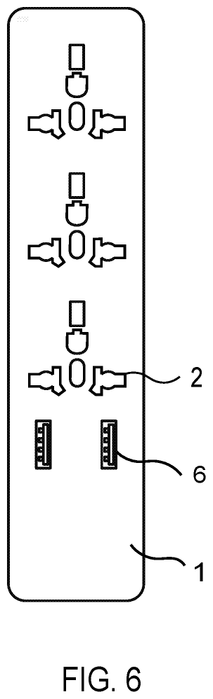

FIG. 6 shows that a USB power outlet 6 can also be used as an add-on option. A USB output power is usually with about 1-2 DC amps output rating.

A regular switch can also be added as an option as needed.

The detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

1. An universal power outlet strip comprising:
a casing,
a power input connection having IEC-320-C14 male connector, and
a plurality of multi-country combination configuration power output contacts; wherein socket geometry of said power output contacts is configured to be simultaneously compatible with power plugs from various countries, socket as a single element is stationary, single socket fits multi-country and when said male connector is engaged with a power cord with an IEC-320-C13 female connector, every said power output contact will be able to distribute power simultaneously.

2. An universal power outlet strip comprising:
a casing,
a power input connection having IEC-320-C14 male connector,
one or a plurality of USB power outlets, and
a plurality of multi-country combination configuration power output contacts; wherein socket geometry of said power output contacts is configured to be simultaneously compatible with power plugs from various countries, socket as a single element is stationary, single socket fits multi-country and when said male connector is engaged with a power cord with an IEC-320-C13 female connector, every said power output contact will be able to distribute power simultaneously.
